(19) United States
(12) Patent Application Publication
(10) Pub. No.: US 2008/0184516 A1
(43) Pub. Date: Aug. 7, 2008

(54) Windscreen Wiper Arm

(75) Inventor: Xavier Boland, Arlon (BE)

Correspondence Address: DICKINSON WRIGHT PLLC, 38525 WOODWARD AVENUE, SUITE 2000, BLOOMFIELD HILLS, MI, 48304-2970, US

(73) Assignee: FEDERAL-MOGUL S.A., AUBANGE (BE)

(21) Appl. No.: 11/665,593

(22) PCT Filed: Oct. 6, 2005
(86) PCT No.: PCT/EP2005/055041

§ 371 Date: Jan. 25, 2008

(30) Foreign Application Priority Data
Oct. 18, 2004 (EP) 04105114.5

(51) Int. Cl. B60S 1/34; B23P 15/00

(52) U.S. Cl. 15/250.34; 29/428

(57) ABSTRACT

A windscreen wiper arm, particularly for automobiles, comprising a mounting head on a drive shaft and an arm member pivotally connected to the mounting head by means of a pivot pin, wherein the arm member has a substantially U-shaped cross-section near said pivot pin comprising two side walls, wherein a part of the mounting head extends between the side walls and beyond said pivot pin, and wherein a spring is hooked with its first end on a pin on the mounting head, with the special feature that said spring is hooked with its second end on the arm member.

The present invention relates to a windscreen wiper arm, particularly for automobiles, comprising a mounting head on a drive shaft and an arm member pivotally connected to the mounting head by means of a pivot pin, wherein the arm member has a substantially U-shaped cross-section near said pivot pin comprising two side walls, wherein a part of the mounting head extends between the side walls and beyond said pivot pin, and wherein a spring is hooked with its first end on a pin on the mounting head.

Such a windscreen wiper arm is known from German patent publication no. 34 33 106 (SWF Auto-Electric GmbH). The arm member described therein is connected to a wiper rod, wherein one end of the wiper rod extends inside the U-shaped cross-section of the arm member. The side walls of the arm member are locally folded around the wiper rod, while a holder is folded around said end of the rod. The spring of this prior art windscreen wiper arm is hooked with its first end on the pin on the mounting head and with its second end on two eyes of the holder.

A disadvantage of the windscreen wiper arm known from the above German patent publication is that that windscreen wiper arm consists of many constructional parts (such as a wiper rod, a holder and a mounting head pin) for accommodating the spring, while complex machinery and tools are needed in manufacturing and mounting said parts, with all expenses involved.

It is an object of the invention to obviate this disadvantage, in the sense that at minimum costs—without using complex machinery and additional tools—a simple windscreen wiper arm with less constructional parts for mounting the spring is proposed. It is noted that the present invention is not restricted to cars, but also refers to rail coaches and other (fast) vehicles.

Thereto, according to the invention a windshield wiper arm mentioned in the preamble is characterized in that said spring is hooked with its second end on the arm member. In other words, by connecting the spring directly to the arm member less raw material is used, while additional tooling steps are avoided.

In a preferred embodiment of a windscreen wiper arm in accordance with the invention said spring is hooked with its second end on a base of the U-shaped cross-section of the arm member. In the alternative or in addition thereto said spring is hooked with its second end on at least one side wall of the U-shaped cross-section of the arm member.

In another preferred embodiment of a windscreen wiper arm according to the invention said spring is hooked with its second end on a lip of said base/side wall, wherein said lip is bend inwardly, that is away from said base/side wall. Particularly, said spring is hooked with its second end into a hole provided in said lip. Said hole is particularly stamped in the material of the arm member before the lip is cut from that material.

In another preferred embodiment of a windscreen wiper arm in accordance with the invention the arm member is made of a plastic material. Preferably, also the mounting head is made of a plastic material.

The invention also refers to an arm member as defined in a windshield wiper arm according to the invention.

The invention also relates to a windscreen wiper device comprising an windshield wiper arm in accordance with the invention. Particularly, said windshield wiper device comprises an elastic, elongated carrier element, as well as an elongated wiper blade of a flexible material, which can be placed in abutment with a windscreen to be wiped, which wiper blade includes opposing longitudinal grooves on its longitudinal sides, in which grooves spaced-apart longitudinal strips of the carrier element are disposed, wherein neighbouring ends of said longitudinal strips are interconnected by a respective connecting piece, which windscreen wiper device comprises a connecting device for the windscreen wiper arm according to the invention. Such a windscreen wiper device is thus designed as a “yokeless” wiper device, wherein use is no longer made of several yokes pivotally connected to each other, but wherein the wiper device is biased by the carrier element, as a result of which is exhibits a specific curvature. The present windscreen wiper arm may comprise a pivot pin on one side thereof, which is inserted sideways into a through hole of the connecting device. It is noted that the present invention is not restricted to such a “yokeless blade”, although being advantageous therein, but also extends to other types of windscreen wiper devices, such as the ones with yokes as referred to above.

Finally, the invention is also directed to a method for manufacturing a windscreen wiper arm, particularly for automobiles, comprising a comprising a mounting head on a drive shaft and an arm member pivotally connected to the mounting head by means of a pivot pin, wherein the arm member has a substantially U-shaped cross-section near said pivot pin comprising two side walls, wherein a part of the mounting head extends between the side walls and beyond said pivot pin, and wherein a spring is hooked with its first end on a pin on the mounting head, characterized in that a lip is cut in a base and/or at least one side wall of the U-shaped cross-section of the arm member, wherein said lip is subsequently bend inwardly away from said base/side wall and wherein said spring is finally hooked with its second end into a hole provided in said lip.

The invention will now be explained in more detail with reference to figures illustrated in a drawing, wherein:

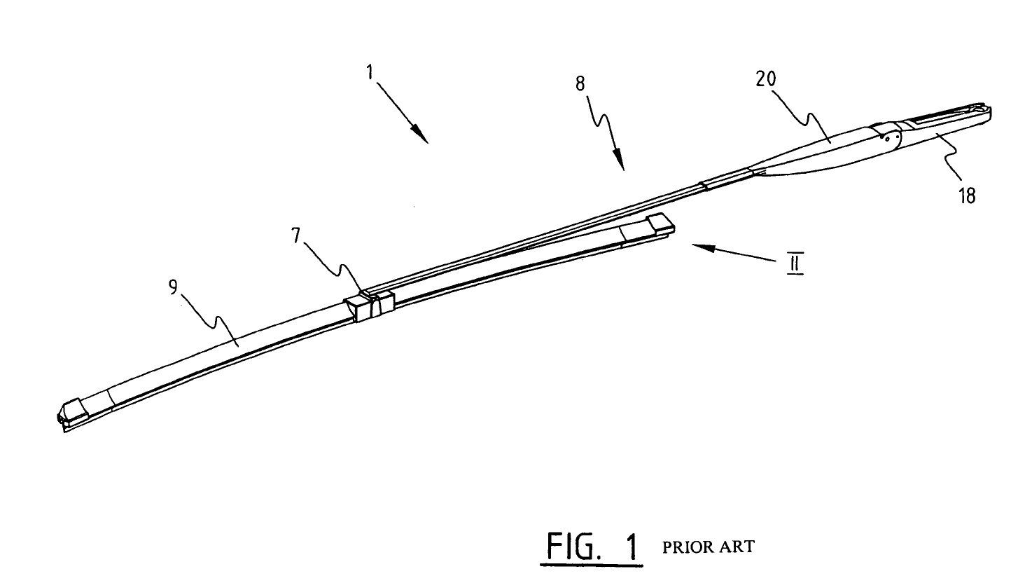

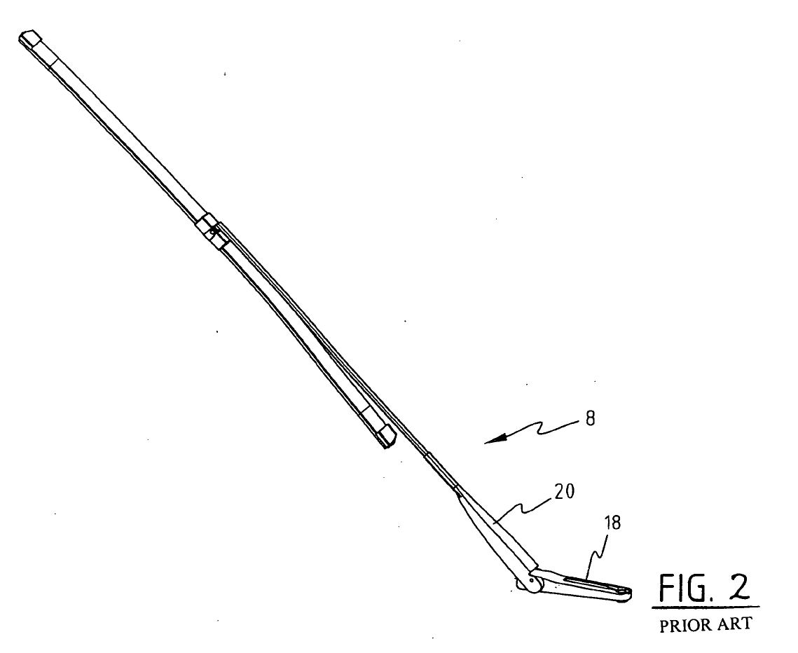

FIGS. 1 and 2 are perspective, schematic views of a prior art windshield wiper device of the “yokeless” type, wherein the windscreen wiper arm is in a wiping position (FIG. 1) and in a mounting position (FIG. 2), respectively;

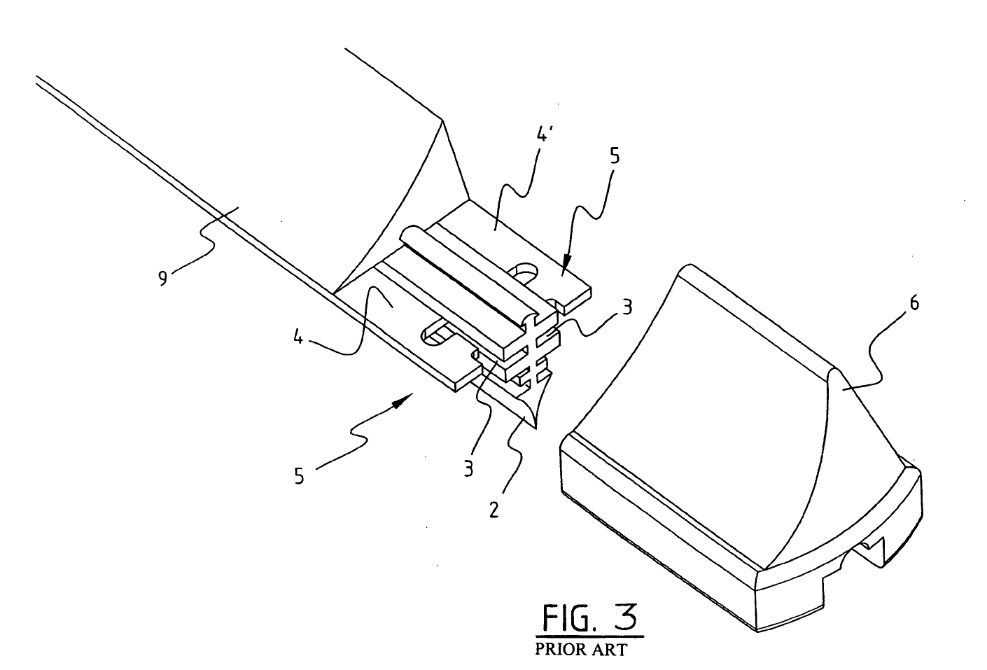

FIG. 3 shows a detail of the windscreen wiper device of FIGS. 1 and 2;

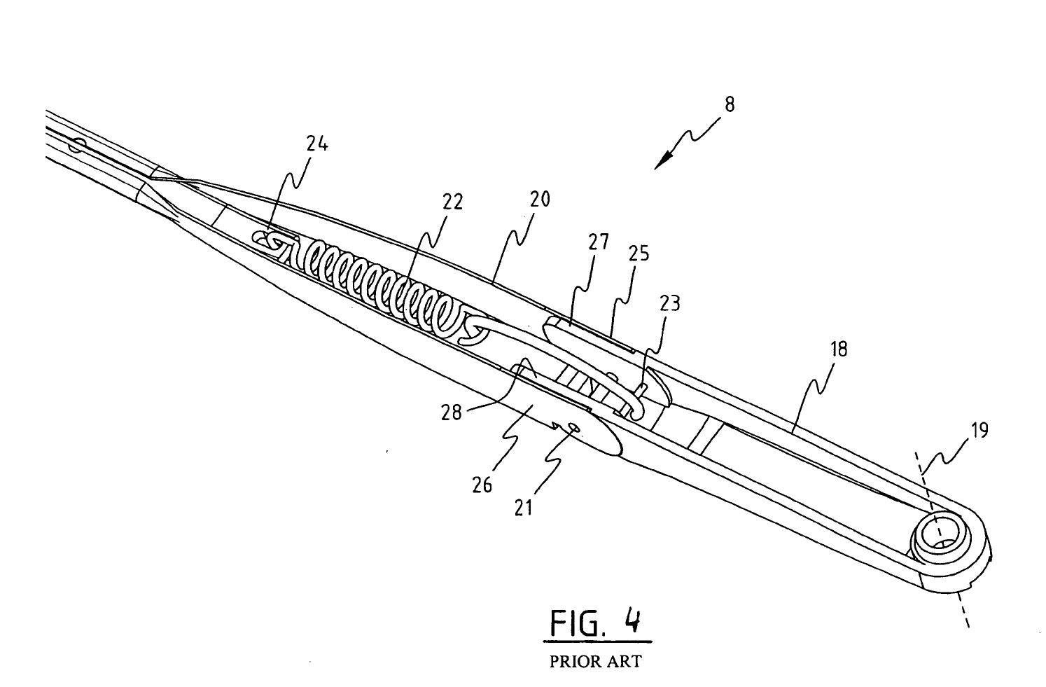

FIG. 4 is a bottom view of the windscreen wiper arm of FIGS. 1 and 2; and

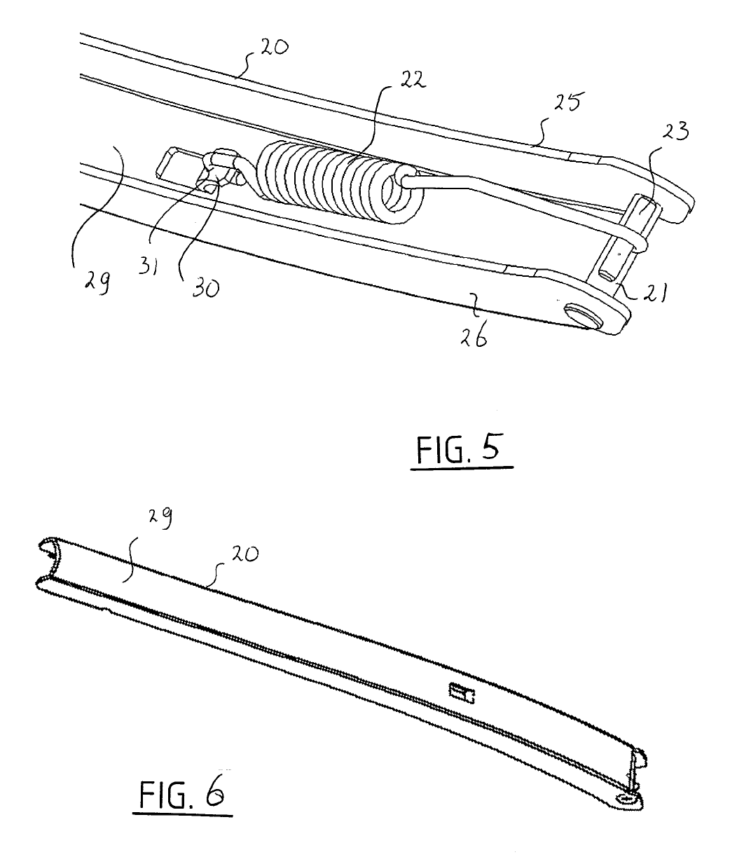

FIGS. 5 and 6 are a bottom view and a top view, respectively, of a windscreen wiper arm according to the invention to be used in a windscreen wiper device of the type of FIGS. 1 and 2.

FIGS. 1 through 4 show a windscreen wiper device 1 according to the prior art. Said windscreen wiper device is built up of an elastomeric wiper blade 2, in the longitudinal sides of which opposing longitudinal grooves 3 are formed, and of longitudinal strips 4 made of spring band steel, which are fitted in said longitudinal grooves 3. Said strips 4 form a flexible carrier element for the rubber wiper blade 2, as it were, which is thus biased in a curved position (the curvature in operative position being that of a windscreen to be wiped). Neighbouring ends 5 of strips 4 are interconnected on either side of the windscreen wiper device 1 by means of connecting pieces 6. The windscreen wiper device 1 is further equipped with a connecting device 7 for an oscillating arm 8, and a spoiler 9.

FIGS. 1 and 2 show the windscreen wiper device 1 in a wiping position and in a mounting position respectively, whereas FIG. 3 shows a free end of the windscreen wiper device 1 of FIG. 1.

As illustrated in FIG. 4 the windscreen wiper arm 8 according to the prior art comprises a plastic mounting head 18 which can be fixed for rotation to a shaft 19 driven, via a mechanism not illustrated, by a small motor. Said windscreen wiper arm 8 further comprises a plastic arm member 20 supported by the mounting head 18, wherein said arm member 20 in turn supports the wiperblade 2 with the help of the connecting device 7, as illustrated in FIG. 1. The arm member 20 is pivotally connected to the mounting head 18 by means of a pivot pin 21. A spring 22 is hooked with its first end on a pin 23 on the mounting head 18 and with its second end on to a wiper rod 24 of the arm 8 in order to ensure that the arm member 20 and thus the wiper blade 2 connected thereto is pressed onto a windscreen to be wiped. In use, the shaft 19 rotates alternately in a clockwise and in a counter-clockwise sense carrying the mounting head 18 into rotation also, which in turn draws the arm member 20 into rotation and by means of the connecting device 7 moves the wiper blade 2.

With reference to FIGS. 5 and 6 according to the invention a spring 22 is accommodated in a metallic arm member 20, wherein said spring 22 is hooked with its first end on a pin 21 of a mounting head 18 of the type shown in FIGS. 1, 2 and 4, and wherein said spring 22 is hooked with its second end on a base 29 of the U-shaped cross-section of the arm member 20. Particularly, said spring 22 is hooked with its second end on a lip 30 of said base 29. Said lip 30 is bend inwardly, i.e. away from said base 29. More in particular, said spring 22 is hooked with its second end into a hole 31 provided in said lip 30. Parts in FIGS. 5 and 6 that correspond to those of FIG. 4 are designated with the same reference numerals.

The invention is not restricted to the embodiment shown, but also extends to other embodiments falling within the scope of the appended claims.

1-7. (canceled)

8. A windscreen wiper arm comprising a mounting head on a drive shaft and an arm member pivotally connected to the mounting head by means of a pivot pin, wherein the arm member has a substantially U-shaped cross-section near said pivot pin comprising two side walls and a base wall that extends between the side walls and beyond said pivot pin, and wherein a spring is hooked with its first end on a pin on the mounting head and with its second end on the arm member, characterized in that said spring is hooked with its second end on a lip cut in at least one of said base or said at least one of said side walls of the U-shaped cross-section of the arm member, wherein said lip is bent inwardly away form said at least one of said or said side wall.

9. A windscreen wiper arm according to claim 8, wherein said spring is hooked with its second end into a hole provide din said lip.

10. A windscreen wiper arm according to claim 8, wherein the arm member is made of a plastic material.

11. A windshield wiper arm according to claim 8, including an elastic, elongated carrier element, an elongated wiper blade of a flexible material, which can be placed in abutment with a windscreen to be wiped, which wiper blade includes opposing longitudinal grooves on its longitudinal sides, in which grooves spaced-apart longitudinal strips of the carrier element are disposed, wherein neighboring ends of said longitudinal strips are interconnected by a respective connecting piece, and a connecting device.

12. A method for manufacturing a windscreen wiper arm, comprising a mounting head on a drive shaft and an arm member pivotally connected to the mounting head by means of a pivot pin, wherein the arm member has a substantially U-shaped cross-section near said pivot pin comprising two side walls and a base wall that extends between the side walls and beyond said pivot pin, and wherein a spring is hooked with its first end on a pin on the mounting head, and including a lip cut in at least one of the base wall or at least one of said side walls of the U-shaped cross-section of the arm member, wherein the lip is subsequently bent inwardly and the spring is hooked with its second end into a hole provided in the lip.
